(19) United States
(12) Patent Application Publication
(10) Pub. No.: US 2026/0370659 A1
(43) Pub. Date: Nov. 19, 2026

(54) Data-Driven Phishing Detection: Cross-Checking Email Metadata Across Platforms for Enhanced Security

(71) Applicant: Rajasekhar Kalamata, Lewisville, TX (US)

(72) Inventor: Rajasekhar Kalamata, Lewisville, TX (US)

(21) Appl. No.: 19/176,145

(22) Filed: Apr. 11, 2025

(51) Int. Cl. H04L 9/40; H04L 51/224

(52) U.S. Cl. CPC H04L 63/1416; H04L 51/224; H04L 63/1425

(57) ABSTRACT

This invention introduces a novel system and method for detecting phishing emails by analyzing and cross-validating email metadata across various platforms, including web browsers, mobile applications, and email clients. The system identifies discrepancies in metadata representation that indicate potential phishing attempts. By leveraging data-driven anomaly detection techniques, the system enhances security by providing alerts when metadata inconsistencies are detected while accounting for legitimate variations.

### BACKGROUND OF THE INVENTION

Phishing attacks remain a prevalent cybersecurity threat, often exploiting differences in how email metadata is displayed across different platforms. Attackers take advantage of the fact that metadata, including sender information and routing data, may appear differently on mobile apps compared to web browsers. This discrepancy can obscure the origin of phishing emails, leading to successful attacks.

Traditional email security solutions primarily focus on content analysis or domain verification (e.g., SPF, DKIM, DMARC), but they often fail when attackers manipulate metadata to appear legitimate on certain platforms. Additionally, some legitimate emails may have different relay paths, even when DMARC checks pass, making it essential to distinguish between legitimate variations and phishing attempts.

### SUMMARY OF THE INVENTION

The invention proposes a data-driven phishing detection system that cross-checks email metadata across different platforms. The method includes extracting metadata from multiple sources, including browser-based email clients, mobile email applications, and desktop email clients. The system then performs comparative analysis to identify inconsistencies that are indicative of phishing attempts while accounting for legitimate relay path variations.

Additionally, the system integrates SPF, DKIM, and DMARC validation to ensure that the detected metadata discrepancies are accurately classified, minimizing false positives. By combining metadata analysis with robust email authentication checks, the system offers enhanced accuracy and reliability in detecting phishing attempts.

### BRIEF DESCRIPTION OF THE DRAWINGS

The accompanying drawings, which are incorporated in and constitute a part of this specification, illustrate embodiments of the invention and, together with the description, serve to explain the principles of the invention.

FIG. 1 is a block diagram illustrating the multi-layered system architecture of the phishing detection system, including the Data Acquisition Layer (100), Metadata Normalization (200), Metadata Comparison Engine (210), Authentication Verification Layer (300), Anomaly Detection Module (400), Alert and Classification Module (500), and Data Visualization Dashboard (510).

FIG. 2 is a flowchart illustrating the phishing identification process, beginning at Start (600), proceeding through Metadata Discrepancy Detection (610), SPF/DKIM/DMARC authentication check (620), and Relay Path validation (630), and resulting in either Flag as Phishing (640) or Mark as Legitimate (650).

FIG. 3 is a workflow diagram illustrating the step-by-step process for detecting phishing emails, from Receive Email (700), Extract Metadata (710), Normalize Metadata (720), Cross-Platform Comparison (730), SPF/DKIM/DMARC Check (740), Relay Path Evaluation (750), Anomaly Detection (760), and Classification (770), through final Alert User (780) or End (790).

### DETAILED DESCRIPTION OF THE INVENTION

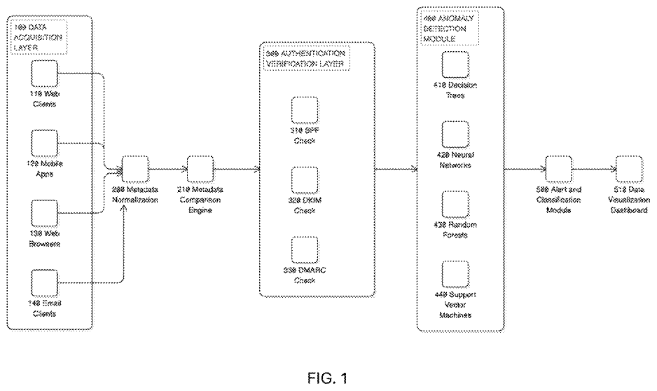

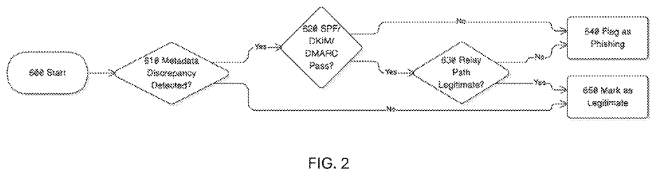

FIG. 1 is a block diagram illustrating a multi-layered architecture to accurately detect phishing emails through metadata analysis and authentication checks. The primary components include:
1. Data Acquisition Layer (100):
   a. Extracts metadata from emails accessed via mobile apps, mobile browsers, and web browsers, comprising Web Clients (110), Mobile Apps (120), Web Browsers (130), and Email Clients (140).
   b. Captures key metadata fields such as ‘From’, ‘Reply-To’, ‘Return-Path’, ‘Received’, and ‘DKIM-Signature’.
2. Metadata Normalization (200):
   a. Standardizes the extracted metadata fields across platforms to enable uniform analysis.
   b. Normalizes data formats, including email addresses, domain names, and IP addresses.
3. Metadata Comparison Engine (210):
   a. Compares metadata attributes from different platforms to identify inconsistencies.
   b. Uses pattern matching and statistical anomaly detection to recognize suspicious variations.
4. Authentication Verification Layer (300):
   a. Conducts SPF Check (310), DKIM Check (320), and DMARC Check (330) to validate the sender's domain authenticity.
   b. Cross-references relay paths against known trusted proxies to reduce false positives.
5. Anomaly Detection Module (400):
   a. Employs machine learning algorithms including Decision Trees (410), Neural Networks (420), Random Forests (430), and Support Vector Machines (440), to detect atypical patterns indicative of phishing.
   b. Incorporates heuristic rules to flag inconsistencies that deviate from expected legitimate email practices.
6. Alert and Classification Module (500):
   a. Flags suspicious emails and categorizes them as phishing or legitimate based on the anomaly score and authentication results.
   b. Marks the email as suspicious or junk if the anomaly score exceeds a predefined threshold.
   c. Provides notifications to users and system administrators when a potential phishing attempt is identified.
7. Data Visualization Dashboard (510):
   a. Presents detected discrepancies in a user-friendly format, highlighting differences across platforms.
   b. Allows administrators to view flagged emails and analyze metadata variations visually.
   c. Facilitates faster decision-making by presenting metadata discrepancies in a clear, intuitive way, reducing the time required to investigate potential phishing threats.
   d. Empowers users to recognize phishing patterns through graphical representations, aiding in pattern recognition and proactive threat management.
   e. Supports auditing and historical analysis, helping administrators track recurring phishing techniques and refine detection strategies.
FIG. 2 illustrates the phishing identification process executed by the system. The process begins at Start (600). The system performs a Metadata Discrepancy Detection (610) to identify inconsistencies across multiple platforms. If discrepancies are detected, the system proceeds to an SPF/DKIM/DMARC authentication check (620) to verify the sender's identity. Further validation is performed through a Relay Path validation (630) to ensure the email was routed through legitimate servers. Based on these cumulative results, the system will either Flag as Phishing (640) or Mark as Legitimate (650).

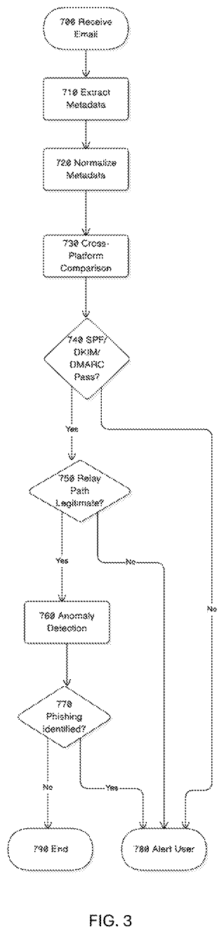

FIG. 3 illustrates the step-by-step phishing detection workflow. The workflow commences when the system receives an email (700). The system extracts metadata (710) and normalizes it (720) for cross-platform comparison (730). An authentication check (740) for SPF, DKIM, and DMARC is performed. The system then evaluates the relay path (750) to determine if it is legitimate. An anomaly detection (760) module then calculates a risk score, leading to a final classification (770). Depending on the classification, the system will either Alert the User (780) of a potential threat or reach the End (790) of the processing cycle for a safe email.

Consider a phishing email pretending to be from Coinbase with the sender ID ‘noreply@coinbase.com via delnext.com’. The system detects that ‘delnext.com’ is not an authorized relay domain associated with Coinbase. Furthermore, the SPF and DMARC checks fail, indicating that the email is likely spoofed. As a result, the system correctly flags this email as a phishing attempt, alerting the user to potential risk.

On the other hand, an email from FIDELITY INVESTMENTS with the sender ID ‘@proxyvote.com’ may appear suspicious due to the discrepancy between the display name and domain. However, the system verifies that ‘@proxyvote.com’ is an authorized proxy domain used by Fidelity Investments for legitimate purposes. As a result, the system correctly identifies this email as legitimate, avoiding a false positive.

### Core Benefits and Features

1. Cross-Platform Consistency: Unlike traditional phishing detection methods, this system can analyze metadata across multiple platforms (mobile apps, browsers, and desktop clients), providing a more comprehensive approach.
2. Enhanced Accuracy: By integrating SPF, DKIM, and DMARC validation, the system reduces false positives, making detection more reliable.
3. Reduced Human Error: Automating the metadata comparison reduces the reliance on manual inspection, minimizing human error.
4. Real-Time Alerts: Immediate notification of potential phishing attempts allows for quick response and mitigation.
5. Proactive Threat Management: The visualization tool helps administrators recognize phishing patterns and refine security policies proactively.
6. Adaptive Detection: Incorporates machine learning to adapt to new phishing techniques, maintaining effectiveness over time.

### Potential Applications

1. Email Clients: Integrating the phishing detection system directly into popular email applications (e.g., Gmail, Outlook) to enhance built-in security.
2. Enterprise Security Solutions: Embedding the system into corporate email gateways to safeguard against phishing attacks targeting employees.
3. Browser Extensions: Developing browser plugins that analyze metadata discrepancies directly within web-based email clients.
4. Email Filtering Services: Enhancing existing spam and phishing filters by incorporating cross-platform metadata comparison and validation.
5. Cybersecurity Platforms: Integrating with SIEM (Security Information and Event Management) systems to provide real-time alerts and visualization of phishing attempts.

### CONCLUSION

The proposed data-driven phishing detection system offers a comprehensive approach by leveraging cross-platform metadata comparison combined with robust authentication validation (SPF, DKIM, DMARC). By addressing the limitations of traditional content-based methods, this system reduces false positives and enhances detection accuracy. Its multi-layered architecture, incorporating machine learning and anomaly detection, ensures adaptability against evolving phishing techniques. Through real-time alerts, visualization, and proactive threat management, this invention significantly improves email security for both individual users and organizations.

1. (canceled)

2. (canceled)

3. (canceled)

4. (canceled)

5. (canceled)

6. (canceled)

7. (canceled)

8. (canceled)

9. (canceled)

10. (canceled)

11. A system for detecting phishing emails comprising: a data acquisition layer configured to extract email metadata from emails accessed via mobile applications, mobile browsers, and web browsers, wherein the metadata includes fields comprising From, Reply-To, Return-Path, Received, and DKIM-Signature headers; a metadata normalization module configured to standardize the extracted metadata fields across platforms to enable uniform cross-platform analysis; a metadata comparison engine configured to compare metadata attributes from different platforms to identify inconsistencies indicative of phishing attempts; an authentication verification layer configured to conduct SPF, DKIM, and DMARC checks to validate sender domain authenticity and cross-reference relay paths against known trusted proxy domains; and an anomaly detection module configured to detect atypical metadata patterns and generate a phishing risk score based on identified metadata discrepancies and authentication results.

12. A method for detecting phishing emails comprising: extracting email metadata from a plurality of platforms including mobile applications, mobile browsers, and web browsers; normalizing the extracted metadata to enable consistent cross-platform comparison; comparing normalized metadata attributes across the plurality of platforms to identify discrepancies indicative of phishing attempts; performing SPF, DKIM, and DMARC authentication checks on the extracted metadata to validate sender domain authenticity; computing an anomaly score based on identified metadata discrepancies and authentication failures; and classifying the email as phishing or legitimate based on the computed anomaly score exceeding a predefined threshold.

13. (canceled)

14. The system of claim 11, wherein the anomaly detection module employs machine learning algorithms to detect atypical metadata patterns and adapts to new phishing techniques over time.

15. The system of claim 11, further comprising an alert and classification module configured to flag suspicious emails, categorize them as phishing or legitimate based on the phishing risk score and authentication results, and provide real-time notifications to users and system administrators.

16. The system of claim 11, further comprising a trusted domain validation feature configured to cross-reference known legitimate proxy domains to minimize false positives when relay path discrepancies are detected.

17. The system of claim 11, further comprising an administrative data visualization dashboard configured to display detected metadata discrepancies across platforms, highlight inconsistencies in a user-friendly format, and support auditing and historical analysis of phishing attempts.

18. The method of claim 12, wherein the extracted email metadata comprises a From header and a Return-Path header, and wherein comparing normalized metadata attributes further comprises detecting a mismatch between a domain of the Return-Path header and a domain of the From header, wherein the mismatch is not attributable to a known legitimate email service provider.

19. (canceled)
